(19) United States
(12) Patent Application Publication
(10) Pub. No.: US 2016/0313583 A1
(43) Pub. Date: Oct. 27, 2016

(54) DISPLAY PANEL AND LIQUID CRYSTAL DISPLAY DEVICE

(71) Applicants: BOE TECHNOLOGY GROUP CO., LTD., Beijing (CN); HEFEI BOE OPTOELECTRONICS TECHNOLOGY CO., LTD., Anhui (CN)

(72) Inventor: Zhihai ZHANG, Beijing (CN)

(73) Assignees: BOE TECHNOLOGY GROUP CO., LTD., Beijing (CN); HEFEI BOE OPTOELECTRONICS TECHNOLOGY CO., LTD., Anhui (CN)

(21) Appl. No.: 15/070,097

(22) Filed: Mar. 15, 2016

(30) Foreign Application Priority Data
Apr. 24, 2015 (CN) 201510204786.3

(51) Int. Cl. G02F 1/1339; G02B 5/20; G02F 1/1335

(52) U.S. Cl. CPC G02F 1/1339; G02F 1/133514; G02B 5/201

(57) ABSTRACT

The present disclosure provides a display panel and a liquid crystal display device. The display panel includes an array substrate, a color filter substrate, and a sealant arranged between the array substrate and the color filter substrate and added with particles. At least a part of the particles have, at their surfaces, first delimiting mechanisms for increasing a frictional force between the adjacent particles.

### CROSS-REFERENCE TO RELATED APPLICATION

This application claims a priority of the Chinese Patent Application No. 201510204786.3 filed on Apr. 24, 2015, the disclosures of which are incorporated in their entirety by reference herein.

### TECHNICAL FIELD

The present disclosure relates to the field of display technology, in particular to a display panel and a liquid crystal display device.

### BACKGROUND

A display panel of a liquid crystal display device includes an array substrate, a color filter substrate, a liquid crystal layer arranged between the array substrate and the color filter substrate, a post spacer arranged between the array substrate and the color filter substrate, and a sealant for connecting the array substrate and the color filter substrate to form a cell. The sealant may be doped with some particles, so as to maintain a cell thickness when the array substrate and the color filter substrate arranged opposite to each other to form a cell.

During the manufacture of the display panel, it is required to reduce a thickness of a product, and to polish some of the resultant products, so as to meet the market demand. However, during the polishing treatment, the sealant in the existing display panel may easily be deformed under the effect of a shear force generated between the array substrate and the color filter substrate. At this time, the array substrate may be displaced relative to the color filter substrate, and a surface of an alignment film may be damaged by the post spacer of the display panel. Further, debris may occur in the display panel, and as a result, the yield and the operational stability of the display panel will be attenuated.

### SUMMARY

An object of the present disclosure is to provide a display panel and a liquid crystal display device, so as to increase a frictional force between the particles in the sealant and provide the sealant with a stable structure, thereby to reduce the deformation of the sealant during the polishing treatment due to the shear force generated between the array substrate and the color filter substrate, prevent the array substrate from being displaced relative to the color filter substrate, prevent the occurrence of the debris when the surface of the alignment film is damaged by the post spacer, and improve the yield and the operational stability of the product.

In one aspect, the present disclosure provides in some embodiments a display panel, including an array substrate, a color filter substrate, and a sealant arranged between the array substrate and the color filter substrate and added with particles. At least a part of the particles have, at their surfaces, first delimiting mechanisms for increasing a frictional force between the adjacent particles.

According to the display panel in the embodiments of the present disclosure, the at least a part of particles have, at their surfaces, the first delimiting mechanisms, so there is a large frictional force between the adjacent particles, and it is able to provide the sealant with a stable structure. During the polishing treatment of the display panel, the sealant may not be deformed easily due to the shear force generated between the array substrate and the color filter substrate. As a result, it is able to prevent the array substrate from being displaced relative to the color filter substrate, thereby to prevent the occurrence of the debris in the display panel when a surface of an alignment film is damaged by a post spacer of the display panel, and improve the yield and the operational stability of the product.

Alternatively, the particles are SiO₂ particles.

Alternatively, the first delimiting mechanism formed at the surface of each SiO₂ particle which has the first delimiting mechanisms includes bulges.

Alternatively, the first delimiting mechanisms formed at the surfaces of a part of the SiO₂ particles which have the first delimiting mechanisms include bulges, and the first delimiting mechanisms formed at the surfaces of the other part of the SiO₂ particles which have the first delimiting mechanisms include depressions.

Alternatively, the first delimiting mechanism formed at the surface of each SiO₂ particle which has the first delimiting mechanisms includes both bulges and depressions.

Alternatively, second delimiting mechanisms are formed at surfaces of the array substrate and the color filter substrate engaged with the sealant.

According to the display panel in the embodiments of the present disclosure, the second delimiting mechanisms formed at the surfaces of the array substrate and the color filter substrate engaged with the sealant may cooperate with the first delimiting mechanisms formed at the surfaces of the SiO₂ particles in the sealant, so as to increase an adhesion force between the sealant and the array substrate as well as the color filter substrate, thereby to further prevent the array substrate from being displaced relative to the color filter substrate during the polishing treatment, and further improve the yield and the operational stability of the product.

Alternatively, the second delimiting mechanism includes bulges and/or depressions.

In another aspect, the present disclosure provides in some embodiments a liquid crystal display device including the above-mentioned display panel.

### BRIEF DESCRIPTION OF THE DRAWINGS

FIG. 1 is a schematic view showing a principle for the generation of debris during the polishing treatment of a display panel; and

FIG. 2 is a schematic view showing a SiO₂ particle with bulges as a first delimiting mechanism according to one embodiment of the present disclosure.

### DETAILED DESCRIPTION OF THE EMBODIMENTS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

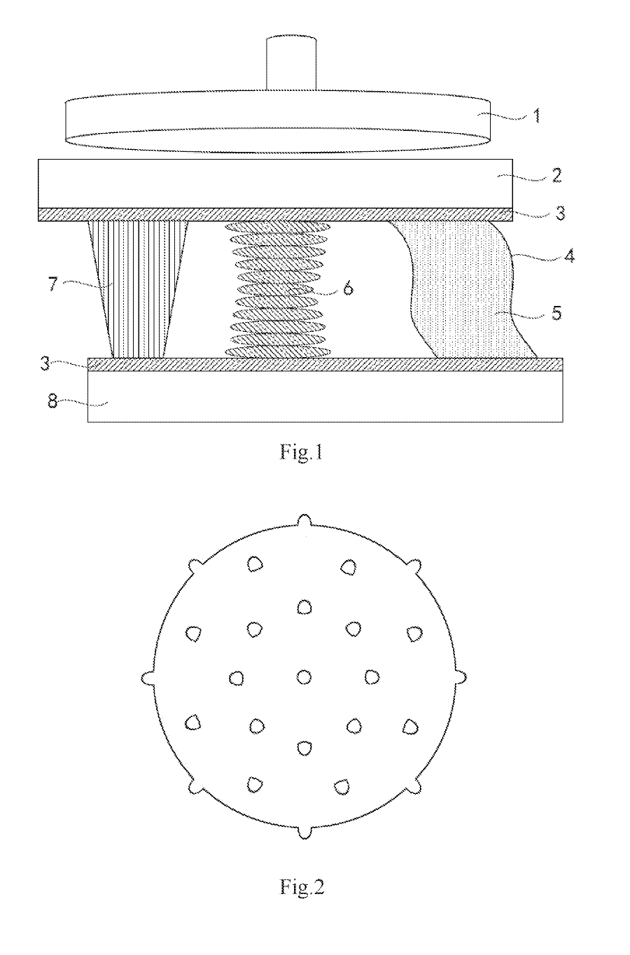

As shown in FIG. 1, which shows a principle for the generation of debris during the polishing treatment, a display panel includes an array substrate 8, a color filter substrate 2, a liquid crystal layer 6 arranged between the array substrate 8 and the color filter substrate 2, a post spacer 7 arranged between the array substrate 8 and the color filter substrate 2, and a sealant 4 for connecting the array substrate 8 and the color filter substrate 2 to form a cell. The sealant 4 may be doped with some particles 5 at a certain proportion, so as to maintain a cell thickness after the array substrate 8 and the color filter substrate 2 are arranged opposite to each other to form a cell. Each particle 5 is of a spherical or approximately spherical shape. During the polishing treatment, when a force is applied by a polishing device 1 onto the color filter substrate 2, a shear force is generated in the sealant 4 arranged between the color filter substrate 2 and the array substrate 8. There is a relatively small frictional force between the spherical or approximately spherical particles 5, so the structure of the sealant 4 is unstable, and the sealant 4 may be easily deformed under the effect of the shear force. At this time, the color filter substrate 2 may be displaced relative to the array substrate 8, and thereby an alignment film 3 may be damaged by a post spacer 7 between the color filter substrate 2 and the array substrate 8 to generate the debris. As a result, the yield and the operational stability of the display panel may be adversely affected.

The present disclosure provides in some embodiments a display panel and a liquid crystal display device. The display panel includes an array substrate, a color filter substrate, and a sealant arranged between the array substrate and the color filter substrate and added with particles. At least a part of the particles have, at their surfaces, first delimiting mechanisms for increasing a frictional force between the adjacent particles.

According to the display panel in the embodiments of the present disclosure, the at least a part of particles have, at their surfaces, the first delimiting mechanisms, so there is a large frictional force between the adjacent particles, and it is able to provide the sealant with a stable structure. Therefore, during the polishing treatment of the display panel, the sealant may not be deformed easily due to the shear force generated between the array substrate and the color filter substrate. As a result, it is able to prevent the array substrate from being displaced relative to the color filter substrate, thereby to prevent the occurrence of the debris in the display panel when a surface of an alignment film is damaged by a post spacer of the display panel, and improve the yield and the operational stability of the product.

Alternatively, the particles are SiO₂ particles.

The first delimiting mechanism for increasing the frictional force between the adjacent SiO₂ particles will be described hereinafter.

Alternatively, as shown in FIG. 2, the first delimiting mechanism formed at the surface of each SiO₂ particle which has the first delimiting mechanisms may include bulges.

Alternatively, the first delimiting mechanisms formed at the surfaces of a part of the SiO₂ particles which have the first delimiting mechanisms may include bulges as shown in FIG. 2, and the first delimiting mechanisms formed at the surfaces of the other part of the SiO₂ particles which have the first delimiting mechanisms may include depressions.

Alternatively, the first delimiting mechanism formed at the surface of each SiO₂ particle which has the first delimiting mechanisms may include both bulges and depressions.

Of course, the first delimiting mechanism may be of any other structures, which are not particularly defined herein.

In an alternative embodiment, second delimiting mechanisms may be formed at surfaces of the array substrate and the color filter substrate engaging with the sealant while forming the first delimiting mechanisms.

At this time, the second delimiting mechanism may cooperate with the first delimiting mechanism, so as to increase an adhesion force between the sealant and the array substrate as well as the color filter substrate, thereby to further prevent the array substrate from being displaced relative to the color filter substrate during the polishing treatment, and further improve the yield and the operational stability of the product.

Alternatively, the second delimiting mechanism may include bulges and/or depressions described above.

Of course, the second delimiting structure may be of any other structures, which are not particularly defined herein.

The above are merely the preferred embodiments of the present disclosure. It should be appreciated that, a person skilled in the art may make further modifications and improvements without departing from the spirit of the present disclosure, and these modifications and improvements shall also fall within the scope of the present disclosure.

What is claimed is:

1. A display panel, comprising:
an array substrate,
a color filter substrate, and
a sealant arranged between the array substrate and the color filter substrate and added with particles,
wherein at least a part of the particles have, at their surfaces, first delimiting mechanisms for increasing a frictional force between the adjacent particles.

2. The display panel according to claim 1, wherein the particles are SiO₂ particles.

3. The display panel according to claim 2, wherein the first delimiting mechanism formed at the surface of each SiO₂ particle which has the first delimiting mechanisms comprises bulges.

4. The display panel according to claim 2, wherein the first delimiting mechanisms formed at the surfaces of a part of the SiO₂ particles which have the first delimiting mechanisms comprise bulges, and the first delimiting mechanisms formed at the surfaces of the other part of the SiO₂ particles which have the first delimiting mechanisms comprise depressions.

5. The display panel according to claim 2, wherein the first delimiting mechanism formed at the surface of each SiO₂ particle which has the first delimiting mechanisms comprises both bulges and depressions.

6. The display panel according to claim 1, wherein second delimiting mechanisms are formed at surfaces of the array substrate and the color filter substrate engaged with the sealant.

7. The display panel according to claim 6, wherein the second delimiting mechanism comprises bulges and/or depressions.

8. The display panel according to claim 2, wherein second delimiting mechanisms are formed at surfaces of the array substrate and the color filter substrate engaged with the sealant.

9. The display panel according to claim 3, wherein second delimiting mechanisms are formed at surfaces of the array substrate and the color filter substrate engaged with the sealant.

10. The display panel according to claim 4, wherein second delimiting mechanisms are formed at surfaces of the array substrate and the color filter substrate engaged with the sealant.

11. The display panel according to claim 5, wherein second delimiting mechanisms are formed at surfaces of the array substrate and the color filter substrate engaged with the sealant.

12. A liquid crystal display device, comprising the display panel according to claim 1.

13. The liquid crystal display device according to claim 12, wherein the particles are SiO₂ particles.

14. The liquid crystal display device according to claim 13, wherein the first delimiting mechanism formed at the surface of each SiO₂ particle which has the first delimiting mechanisms comprises bulges.

15. The liquid crystal display device according to claim 13, wherein the first delimiting mechanisms formed at the surfaces of a part of the SiO₂ particles which have the first delimiting mechanisms comprise bulges, and the first delimiting mechanisms formed at the surfaces of the other part of the SiO₂ particles which have the first delimiting mechanisms comprise depressions.

16. The liquid crystal display device according to claim 13, wherein the first delimiting mechanism formed at the surface of each SiO₂ particle which has the first delimiting mechanisms comprises both bulges and depressions.

17. The liquid crystal display device according to claim 12, wherein second delimiting mechanisms are formed at surfaces of the array substrate and the color filter substrate engaged with the sealant.

18. The liquid crystal display device according to claim 17, wherein the second delimiting mechanism comprises bulges and/or depressions.

19. The liquid crystal display device according to claim 13, wherein second delimiting mechanisms are formed at surfaces of the array substrate and the color filter substrate engaged with the sealant.

20. The liquid crystal display device according to claim 14, wherein second delimiting mechanisms are formed at surfaces of the array substrate and the color filter substrate engaged with the sealant.
